(19) United States
(12) Patent Application Publication
(10) Pub. No.: US 2010/0270209 A1
(43) Pub. Date: Oct. 28, 2010

(54) PROCESS AND DEVICE FOR GENERATING MIDDLE DISTILLATE FROM HYDROCARBONACEOUS ENERGY SOURCES

(75) Inventor: Erhard Tschirner, Kothen (DE)

Correspondence Address: LERNER GREENBERG STEMER LLP, P O BOX 2480, HOLLYWOOD, FL, 33022-2480, US

(73) Assignee: BIO-ENERGY-HOLDING AG, Vienna (AT)

(21) Appl. No.: 12/810,108

(22) PCT Filed: Dec. 22, 2008
(86) PCT No.: PCT/EP08/10990

§ 371 Date: Jun. 22, 2010

(30) Foreign Application Priority Data
Jan. 5, 2008 (DE) 10 2008 003 209.3

(51) Int. Cl. C10G 49/22; B01J 19/00

(52) U.S. Cl. 208/100; 422/187

(57) ABSTRACT

A process generates a middle distillate from hydrocarbonaceous energy sources. In the process, at least one hydrocarbonaceous energy source, if appropriate at least one catalyst and if appropriate at least one filler are fed as input materials to a reactor which contains a process oil mixture. The process oil mixed stream is removed from the reactor and heated to a process temperature between 150 degrees C. and 400 degrees C., preferably between 350 degrees C. and 380 degrees C. The heated process oil mixed stream is fed to a degasser. The vaporous middle distillate is separated in the degasser from the heated process oil mixed stream and a process oil mixed stream which is expanded from the vaporous middle distillate is recirculated from the degasser, to the process oil mixture which is present in the reactor.

The invention relates to a process and a device for generating middle distillate from hydrocarbonaceous energy sources.

It is known from the prior art to release the fuels in the form of hydrocarbons contained in residues, not by reaction with oxygen via combustion or gasification, but to release them in material form by catalytic treatment in the absence of air in an oil bath and to obtain them as a valuable material. This serves for avoiding the formation of CO₂ in disposal of residues and serves for producing fuels or propellants from the residues.

The residue in the form of renewable raw materials, such as wood and plant parts, of waste products, such as plastics, of animal and plant wastes, of waste oils and other organic raw materials which contain a preferably high proportion of hydrocarbons and, because of their energetic utilizability can be termed materials of value or energy sources, remains in the oil bath until, by molecular dehydration, molecular polymerization and molecular shortening (depolymerization/conversion into oil) these hydrocarbons can be separated off as hydrocarbon vapor.

DE 100 49 377 C2 discloses a process for converting plastics, fats, oils and other hydrocarbonaceous wastes into oils, wherein a catalyst of sodium aluminum silicates is mixed in a circulation evaporator in a circuit in a high-boiling hydrocarbon, such as thermal oil, base oil or bunker-C oil, and in the reactor part below the distillation system, plastics, fats, oils and other hydrocarbonaceous wastes are added. The reaction site for the conversion reaction into oil is a circulation evaporator system which consists of a tube-bundle evaporator which is heated with flue gas and a reactor connected to two tubes, which reactor needs feed and discharge functions. On the reactor is arranged a distillation column which takes up the catalytically cracked product in vapor form and separates it into the actual product diesel, a fraction for petrol production and reflux into the reactor for a further catalytic cracking reaction. By combustion below the circulation evaporator, hot flue gas is generated and passed through the flue gas tubes of the circulation evaporator. In the circulation evaporator the hot flue gases cool down, wherein in the lower part of the circulation evaporator temperatures of approximately 430 to 470° result on the inside of the tubes, where the catalyst-containing oils pass onto the tubes together with the molten residues, which leads to a selective catalytic cracking of the residues to form a hydrocarbon vapor.

The high temperature of the hot flue gases leads to the formation of reaction coke which reacts with the sodium-doped aluminum silicate to form a nonreactive residue which fouls the plant and brings the reaction to a stop. This reaction mixture of the catalyst and the reaction coke combines with the walls of the circulation evaporator and the reactor to form a hard residue and requires a high expenditure on cleaning in short maintenance intervals. Economic operation of the known process is therefore only possible with restrictions. Furthermore, only low yields are achieved of the heating value of the input substances.

EP 1 538 191 A1 discloses a process for generating diesel oil from hydrocarbonaceous residues in an oil circuit with solids deposition and product distillation for the diesel product, wherein the main energy application and thereby the main heating proceeds via one or more pumps and wherein the flow energy of the pump is braked by a counterrotating stirrer and is intended to be converted into heat. Active energy input via heating through the wall is not provided in this process. Instead, the heat is not transported through the wall, but is liberated directly in the reaction system. The stirrer in this case serves also for complete cleaning of the surfaces arranged in the circuit. Industrial conversion of the process known in EP 1 538 191 A1 is problematical. Furthermore, process stability may be set only with difficulty. Furthermore, the previously described process is distinguished by a lower heating value yield of the input substances.

DE 10 2005 056 735 B3 discloses a high-performance chamber mixer for catalytic oil dispersions as a reactor for depolymerization and polymerization of hydrocarbonaceous residues to middle distillate. The energy input and conversion rate take place predominantly in the high-performance chamber mixer, wherein the pump efficiency of the high-performance chamber mixer is low, that is to say the energy introduced is for the most part converted into mixing energy and friction energy. This process also has a low process stability.

The object of the present invention is to provide a process for generating middle distillate from hydrocarbonaceous energy sources which is inexpensive, is of low complexity in terms of the process and ensures firstly high process stability and secondly a high yield of the heating value of the energy sources used.

For achieving the abovementioned object, a process of the type mentioned at the outset provides that at least one hydrocarbonaceous energy source, optionally at least one catalyst and optionally at least one additive, wherein the additive can be a neutralizer, are fed as input material to a reactor containing a process oil mixture, wherein a process oil mixture stream is removed from the reactor and heated to a process temperature between 150° C. and 400° C., preferably between 350° C. and 380° C., wherein the thus heated process oil mixture stream is fed to a degasser, wherein, in the degasser, vaporous middle distillate, namely vaporous hydrocarbon compounds in the boiling range of the middle distillate fraction of mineral oil, is separated or removed from the heated process oil mixture stream and wherein a process oil mixture stream relieved of the vaporous middle distillate is recirculated from the degasser to the process oil mixture present in the reactor.

The invention first provides heating outside the reactor the process oil mixture stream which was removed from the reactor to temperatures of a maximum of 400° C., preferably of a maximum of 350° C. to 380° C., in such a manner that the formation of reaction coke is reduced. The heating is performed in a gradient-minimized manner. In this context the process according to the invention provides that, during the heating of the process oil mixture temperature peaks, such as occur during heating of the process oil mixture in the process known from DE 100 49 377 C2 on the tube bundles of the evaporator can be excluded in the heat transfer by a suitable process procedure. During the heating of the process oil mixture, the maximum temperature over the entire flow cross section should always be below 400° C., preferably below 380° C. By means of the lower coke formation thus effected, the high expenditure on cleaning can be reduced and the maintenance intervals prolonged, which contributes to a high economic efficiency of the process according to the invention. Furthermore, in the case of the invention, a process oil mixture circuit in the actual sense is not provided: in the case of the invention the middle distillate vapor released from the heated process oil mixture is removed in the degasser and only process oil mixture which is relieved from the vaporous middle distillate is recirculated to the reactor. By means of a suitable structural design of the degasser, the yield in the process according to the invention may be significantly increased in comparison with the known processes.

Preferably at least some of the heated process oil mixture stream can be applied from the top into the degasser and divided on internals of the degasser into a multiplicity of substreams, wherein the substreams then flow off in a trickling film flow to the reactor. Preferably, in the degasser, an essentially smooth trickling film flow forms with negligible bubble formation, wherein the substreams of the process oil mixture flow off downwards in a stringlike manner. In connection with the invention, it has surprisingly been found that a calm surface of the trickling film flow contributes to a high yield of the heating value of the energy source used, wherein a droplet-like flowing off of the process oil mixture through the degasser is unwanted and preferably be substantially excluded by appropriate structural design of the internals. Some of the heated process oil mixture stream can also be introduced into the degasser tangentially, preferably below the internals, and flows off in the form of a rotary flow on an inner vessel wall of the degasser downward toward the reactor. By means of the division of the heated process oil mixture stream into a first substream applied from the top into the degasser onto the internals and a second substream introduced tangentially into the degasser below the internals, a large surface area of the process oil mixture is generated in the degasser which leads to a high release of vaporous middle distillate in the degasser.

According to the device, the degasser accordingly comprises a top dividing space and a bottom degassing space, wherein, in the dividing space, flow-guiding and surface-area-increasing internals are provided for dividing a process oil mixture stream and for increasing the surface area of the process oil mixture stream, wherein, preferably, the process oil mixture stream can be delivered centrally into the dividing space from the top onto the internals. The degassing space, furthermore, can comprise at least one inlet for a process oil mixture stream such that the process oil mixture stream can be introduced tangentially into the degasser and flows off downward toward the reactor as a rotary flow in an inner vessel wall of the degassing space. The inlet into the degassing space here is preferably arranged below the flow-guiding and surface area-enlarging internals of the dividing space. The structure of the degasser according to the invention is distinguished by a high self-cleaning ability and is low-maintenance, wherein maximization of the surface area of the process oil mixture flowing through the degasser is ensured with a correspondingly high yield of vaporous middle distillate.

The main energy input during the heating of the process oil mixture stream removed from the reactor to a process temperature of preferably between 350° C. and 380° C. proceeds according to the invention by indirect heat transfer from a preferably liquid heat carrier in at least one static mixer having an integrated heat transfer appliance. According to the device, the static mixer can be constructed as a mixing heat exchanger having a multiplicity of tube bundles for a heat carrier, in particular a thermal oil, and mixing elements between the tube bundles for turbulent mixing of the process oil mixture. Therefore, a heating and intensive mixing of the process oil mixture stream to be heated occur at the same time, by a turbulent mixing of the process oil mixture can develop in the static mixer.

Furthermore, an indirect heat transfer of the process oil mixture contained in the reactor can be provided, wherein a heat transfer from a preferably liquid heat carrier such as, for example, a hot thermal oil, to the process oil mixture can proceed via an outer wall of the reactor. The thermal oil which can be used for heating the process oil mixture stream in the static mixture and for heating the process oil mixture contained in the reactor should preferably have a maximum temperature of below 400° C., in particular below 380° C., in order to avoid or reduce the formation of reaction coke, which ultimately simplifies the maintenance.

According to the device the reactor can comprise a top cylindrical wall section, wherein, preferably, the top wall section is constructed as a double-shell cylinder having a reactor inner wall and a reactor outer wall and wherein, more preferably, in the double shell, a guide appliance which is spirally mounted on at least one reactor wall is provided for a heat carrier. The top wall section comprises a top inlet port and a bottom inlet port for a heat carrier, wherein the heat carrier flows spirally downward along the reactor inner wall. An additional energy input or else cooling of the process oil mixture is thereby possible in the reactor.

The process oil mixture stream which is vapor-relieved of the middle distillate can be deflected on entry into the reactor from the degasser, wherein, preferably, a tangential rotary flow on the reactor wall is generated. The process oil mixture in the reactor is in this case subjected to static mixing.

In a top entry region of the reactor, preferably, internals for deflecting the flow of the relieved process oil mixture recirculated from the degasser to the reactor are provided, wherein the internals are constructed for generating a tangential wall flow along the reactor wall. The reactor is thereby constructed as a static mixer, wherein no active stirring appliances are required. This contributes to an inexpensive structure of the reactor. The reactor can have an inwardly domed vessel bottom, such that a sedimentation cone forms in the bottom region of the reactor, which simplifies the discharge of spent catalyst material, additives and unreacted energy source from the reactor.

In a further embodiment of the process according to the invention, it is possible provide that a further process oil mixture stream is passed from the reactor into a prereactor having mixing appliances, wherein the input material is fed to the prereactor and mixed with the further process oil mixture stream in the prereactor and wherein the resultant hydrocarbon-rich process oil mixture stream is recirculated from the prereactor to the reactor. In the prereactor, predewatering and predegassing occur and a catalytic reaction occurs only to a small extent. In the prereactor, the input material is mixed with process oil mixture which is approximately 350° C. and originates from the (main) reactor, wherein the liquefaction process of the energy source is initiated. The cracking of hydrocarbon compounds, however, is preferably substantially prevented owing to short residence times in the prereactor and then takes place only in the (main) reactor. The prereactor which is preferably constructed as a screw conveyor comprises at least one feed screw, preferably a double screw as feed unit, for the input material and a mixing vessel connected to the feed screw, wherein, more preferably, the feed screw engages as far as to the bottom region of the mixing vessel and comprises mixing flights at the bottom end. This ensures, firstly, an intensive mixing of the input material with the process oil mixture originating from the (main) reactor and secondly ensures good self-cleaning of the feed screw.

In principle, the feed screw is cooled by following input material, wherein, however, in particular when the process is being run down, for reasons of material endurance, cooling of the feed screw can be necessary. In principle, it is also possible that heating of the feed screw is provided in order to ensure a sufficiently high temperature in the prereactor.

For intense mixing, the mixing vessel of the prereactor can comprise at least one bottom inlet for the further process oil mixture stream from the (main) reactor and at least one top outlet for the hydrocarbon-rich process oil mixture stream. The mixing vessel is thereby constructed as a static mixer in which, however, essentially no cracking processes of the energy source take place. Corresponding internals can be provided as a supplement, in order to intensify the mixing. For the same purpose, a tangential feed of the further process oil mixture stream into the mixing vessel can be provided.

Finally, a carrier oil can also be fed to the (main) reactor via the prereactor, in particular via the mixing vessel, which carrier oil forms a component of the process oil mixture in the reactor.

In order to ensure high process stability and a high yield of the heating value of the input material, the volume ratio of the process oil mixture in the (main) reactor to the further process oil mixture in the prereactor should be set to 5:1 to 8:1. This assumes an appropriate structural design of the reactor vessel and the mixing chamber of the prereactor.

The hydrocarbon-rich process oil mixture stream recirculated from the prereactor is mixed with the process oil mixture contained in the reactor and the process oil mixture stream from the degasser which is relieved of the vaporous middle distillate. The hydrocarbon-rich process oil mixture stream is fed into the reactor beneath the internals which are provided in the top region of the reactor for deflecting the flow of the relieved process oil mixture which is recirculated from the degasser into the reactor. The hydrocarbon-rich process oil mixture stream recirculated from the prereactor is preferably in this case introduced tangentially into a mixing zone of the reactor in such a manner that a rotary flow of the entire process oil mixture forms in the reactor. By means of the targeted input of the hydrocarbon-rich process oil mixture stream recirculated from the prereactor, the process oil mixture in the reactor is made to rotate. The direction of rotation of the relieved process oil mixture stream recirculated from the degasser, after entry into the reactor, can in this case correspond to the direction of rotation of the tangentially introduced hydrocarbon-rich process oil mixture stream from the prereactor.

According to the device, the reactor can comprise a bottom part having a conically tapering top wall section and a conically tapering bottom wall section, wherein the top and the bottom wall sections are connected to one another by a cylindrical wall section. The process oil mixture stream which is fed to the static mixer for heating and mixing can be withdrawn in the top region of the conically tapering top wall section, wherein there, at least one outlet is provided. By means of this structure of the reactor it is possible to remove, from a top first sedimentation zone of the reactor, the process oil mixture stream which is to be heated and to pass it to the static mixer having an integrated heat transfer appliance.

In the top region of the conically tapering bottom wall section of the bottom part, at least one further outlet can be provided. This outlet is provided for draining off from a bottom second sedimentation zone of the reactor a process oil mixture stream which is enriched with at least one catalyst and optionally with at least one additive.

For repeated use of the catalyst it is possible to mix the process oil mixture stream from the top first sedimentation zone, which process oil mixture stream is to be heated, with a process oil mixture stream enriched with catalyst and optionally additive from a bottom second sedimentation zone of the reactor and thereby set a defined catalyst concentration in the process oil mixture. The two streams are mixed before entry into the static mixer, so that both streams are intensively mixed and heated in the mixer. Furthermore, an open-loop or closed-loop control appliance can be provided for open-loop or closed-loop control of the volumetric flow ratio of the process oil mixture stream to be heated to the enriched process oil mixture stream.

A substream of the process oil mixture stream to be heated and optionally a further substream of the process oil mixture stream enriched with catalyst and optionally neutralizer form the further process oil mixture stream fed to the prereactor.

Shortly before transport of the process oil mixture stream which is to be heated and optionally of the process oil mixture stream enriched with catalyst into the static mixer, at least one unconsumed catalyst and/or optionally at least one additive can be added from appropriate reservoir containers. In this case the catalyst and/or additive, before addition, is preferably mixed with a carrier oil or emulsified in a carrier oil, which simplifies the mixing.

According to the invention it is further provided that the energy source, the catalyst, and optionally the additive which together can form the input material for the process, are mixed with one another before feed into the prereactor and are heated to a temperature of below 120° C., preferably to approximately 80 to 100° C. In this case, drying and also aggregate formation occur prior to feed of the input material into the prereactor. The energy source in this case is mixed and heated dry with preferably pulverulent catalyst and/or neutralizer, wherein the resultant aggregate has a high reaction surface area and separation does not take place. Furthermore, the aggregate has a longer residence time in the process oil mixture. The yield is further increased thereby.

The invention permits individual concepts of the invention to be combined with one another, even if this is not described individually. Furthermore, an independent inventive meaning is ascribed to the static mixing and increase in surface area of the process oil mixture in the degasser and in the reactor, and also to the premixing of the input material with the process oil mixture in the prereactor, wherein the inventive concepts linked hereby can also independently of one another justify an inventive concept.

The invention will be described hereinafter by way of examples with reference to the drawing. In the drawings

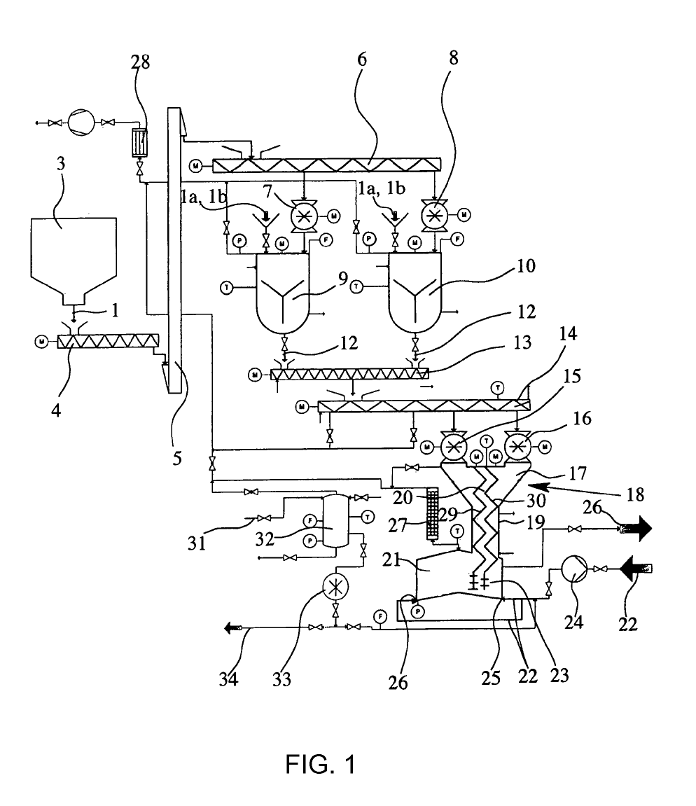

FIG. 1 shows a schematic process flowchart of the feed of a hydrocarbon-rich energy source together with a catalyst and a neutralizer into an oil circuit for generating vaporous middle distillate and

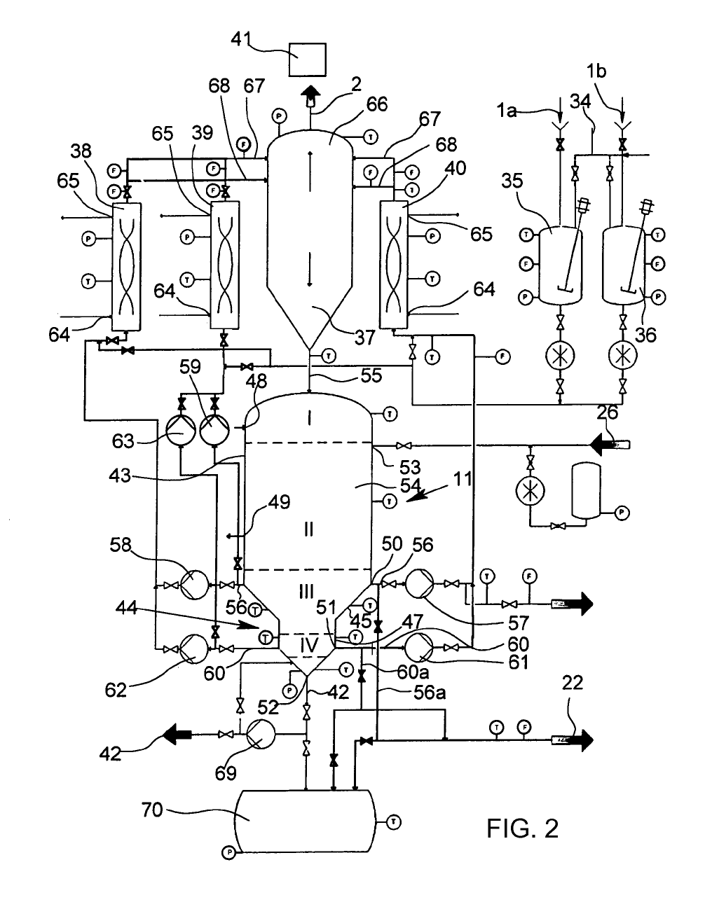

FIG. 2 shows a schematic process flowchart of the reaction circuit for the generation of middle distillate from hydrocarbonaceous energy sources.

FIG. 1 shows a process flowchart which shows the feed of a hydrocarbon-containing energy source 1 into an oil circuit for generating middle distillate 2. The energy source 1, in the present case, is dried and comminuted biomass which is stored in a reservoir vessel 3. The energy source 1 falls owing to gravity from the storage vessel 3 into a first conveyor screw 4. By rotating the spindle, the mixture of matter is pushed into the bottom hopper of a tube chain conveyor 5. The tube chain conveyor 5 transports the energy source 1 to a height of approximately 12 m into a top hopper. From there the energy source 1 falls owing to gravity into a feed screw 6. The feed screw 6 transports the energy source 1 at a rate of 5 m³/h into a first star feeder lock 7 or into a second star feeder lock 8. The star feeder locks 7, 8 serve for periodic metering of starting material to cone mixers 9, 10, wherein each star feeder lock 7, 8 is designed having a transport capacity of 5 m³/h. The star feeder locks 7, 8 are dynamic barriers, since material can be transported through and simultaneously a slight underpressure, generated by a vacuum plant, is made possible in the cone mixers 9, 10.

The cone mixers 9, 10 are degassed in order to decrease the proportion of oxygen and to keep the risk of ignition of the oil vapor produced in the further process low. The cone mixers 9, 10 have a net volume of approximately 2.4 m³. The cone mixers 9, 10 are operated alternately periodically. While the first cone mixer 9 is charged with the energy source 1, the second cone mixer 10 can be mixed using the integrated screw.

In addition to the energy source 1, periodically at least one catalyst 1a and/or one additive 1b, such as, for example a neutralizer, can be added to the cone mixers 9, 10, where the catalyst 1a and the additive 1b can be a pulverulent mixture. The time of mixing, heating, moisture removal and degassing in the cone mixers 9, 10 is approximately half an hour, and the time period of the charging operation is likewise half an hour. Since both cone mixers 9, 10 have a double shell, heating the mixture of matter in the cone mixers 9, 10 to approximately 100° C. is possible. The cone mixers 9, 10 are heated using a heating medium, preferably a thermal oil, such that the input material 12 preferably reaches a temperature of approximately 80° C. in the cone mixers 9, 10. This leads to drying of the input material 12 with agglomerate formation which has an advantageous effect on the yield in the generation of middle distillate 2 from the energy source 1. The temperature elevation is necessary in order to decrease the proportion of water in the mixture, since it vaporizes at this temperature and can be removed via degassing lines of the cone mixers 9, 10. At an excessive water proportion, a water vapor explosion could occur in further processes. In addition, at a high water proportion the effective separation efficiency in the generation of middle distillate from hydrocarbonaceous energy sources 1 would be decreased.

The two cone mixers 9, 10 make possible continuous charging of a four-zone reactor 11 shown in FIG. 2, wherein, via gas-tight slides, the cone mixers 9, 10 are periodically emptied. The input material 12 is discharged from the cone mixers 9, 10, which input material is composed of the energy source 1, optionally the catalyst and optionally at least one additive. The input material 12 passes into a connecting screw 13 and then into a compacting screw 14 in which the input material 12 is pressed to half the original size. The connecting screw 13 and the compacting screw 14 each have a double shell through which a heating medium, preferably thermal oil, is passed at a temperature of approximately 100 to 120° C. This ensures that the temperature of the input material 12 is kept constant at approximately 100° C.

Furthermore, the compacting screw 14 has suction points in order to remove further water proportions, inter alia adhering water, of the dried input material 12. In addition, the proportion of oxygen is further decreased.

From the compacting screw 14, the input material 12 arrives at two ATEX discharge wheels 15, 16. The discharge wheels 15, 16 transport the input material 12 into the filling hopper 17 of a screw feed mixer 18. The screw feed mixer 18 is a prereactor having a mixing appliance and comprises an oval connecting tube 19, a double screw 20 and an approximately 800 1 capacity mixing vessel 21.

The input material 12 is pushed by means of the double screw 20 from the charging hopper 17 through the connecting tube 19 into the mixing vessel 21 and mixed with an approximately 350° C. process oil mixture stream 22 which is withdrawn from the reactor 11 and consists of a carrier oil containing previously dissolved energy source 1 which is in part present in cracked form. The screw ends of the double screw 20 have mixing flights 23 which contribute to the mixing of the input material 12 with the process oil mixture stream 22. The mixing function is supported by metered tangential pumping of the process oil mixture stream 22 from the reactor 11 to the mixing vessel 21 using the spiral housing pump 24, more precisely at two feed points 25, 26 of the mixing vessel 21.

This ensures a double mixing. In addition, the double screw 20 acts as a baffle, since it is situated in the region between the center of the mixing vessel 21 and the wall thereof. By means of the double screw 20, additional turbulence of the flow is caused. The use of a double screw 20 is distinguished, furthermore, by a high operational safety at comparatively high temperatures in the mixing vessel 21.

In the mixing vessel 21 the process oil mixture 22 flows with a rotary motion upwards and mixes with the input material 12 which is transported in. After a short time, a hydrocarbon-rich process oil mixture stream 26 thus obtained is taken off in the top region of the mixing vessel 21 and recirculated to the reactor 11.

When the input material 12 arrives in the screw feed mixer 18, the liquefaction process begins. The cracking process, namely the cracking of the hydrocarbon chains, owing to a very short residence time of the process oil mixture in the screw feed mixer 18, does not start or only to a slight extent, but starts exclusively or predominantly only in the main process in the reactor 11. Should energy source 1 which is still incompletely dissolved be floating on the surface of the reaction mixture in the mixing vessel 21, it is returned or passed back into the mixture via corresponding internals in the mixing vessel 21. If the input material 12 dissolves in the screw feed mixer 18, residual water fractions are released which are passed out of the screw feed mixer 18. The water vapor passes into a demister 27 which contains packings on which oil droplets which are co-transported by the vapor remain adhering and flow off back into the screw feed mixer 18. The water vapor is removed via a vacuum plant and the residual water is liquefied in a condenser 28.

Both spindles 29, 30 of the double screw 20 operate in a self-cleaning manner. The spindles 29, 30 are rotatably mounted at the bottom end at the cone base of the mixing vessel 21 and at the top end by shaft passages of the charging hopper 17. The connecting tube 19 is likewise fitted with a double shell, since temperatures of up to 350° C. can prevail in the mixing vessel 21. The temperature in the charging hopper 17 must not exceed 100° C., since the discharge wheels 15, 16 are designed to have ATEX protection only up to 100° C. Should too much heat flow upwards via the connecting tube 19, it can be removed via the double shell, wherein a corresponding cooling medium is passed through the double shell.

For the introduction of carrier oil 31, such as, for example, dewatered waste oil, into the oil circuit, a heatable vessel 32 is provided as a reservoir vessel. Liquid residues can also be introduced into the oil circuit in this manner as energy source. By means of the pump 33, the carrier oil 31 is introduced into the mixing vessel 21. The vessel 32 is charged via a pump from an oil store. Finally, via the screw feed mixer 18, the carrier oil 31 can be fed to the reactor 11, for example, in order to compensate for vaporization losses. In addition, a carrier oil stream 34 can be passed from the vessel 32 into vessels 35, 36 shown in FIG. 2 for producing a catalyst/additive emulsion. The vessels 35, 36 possess charging hoppers in order to facilitate charging with the catalyst 1a and the additive 1b.

The structure of the feed system shown in FIG. 1 makes possible sufficient drying, mixing and deaeration of the input material 12. There is therefore no risk of a water vapor explosion in the reactor 11. Likewise, the ignition of released oil vapor need not be feared. Finally, by means of a low water proportion in the reactor 11, a high separation efficiency is ensured.

In FIG. 2, the main circulation system in the generation of middle distillate 2 from the hydrocarbonaceous energy source 1 is shown. The components of the main circuit or reaction system are the four-zone reactor 11, a degasser 37 and also three mixing heat exchanger pairs 38, 39, 40 and also a multiplicity of pumps and the associated piping.

In the generation of middle distillate 2 from the hydrocarbonaceous energy source 1, a molecular dehydration, a molecular polymerization and a molecular shortening (depolymerization/conversion to oil) take place at a lower temperature without pressurization, compared with pyrolysis. The process procedure is carried out in the main stream at temperatures between 300 and 400° C. and at a slight underpressure of −30 to −100 mbar compared with the ambient pressure. The described process is characterized by a higher yield of the heating value of the energy source 1. If the energy source 1 used is polymer waste, more than 70 to 80% of the hydrocarbons present can be obtained. Furthermore, detoxification of environmentally relevant halogens by binding them in the liquid state as immobilizable salts takes place.

The hydrocarbon-enriched process oil mixture stream 26 originating from the screw feed mixer 18 as prereactor is introduced into the reactor 11. The process oil mixture 54 contained in the reactor 11 and having the dissolved energy source 1, optionally the catalyst 1a, optionally the additive 1b and carrier oil, is circulated, wherein, per passage, a resulting amount of vaporous middle distillate formed is transferred into a workup system 41 provided above the degasser 37. The workup system 41 is shown only schematically in FIG. 2. The main components of the workup system 41 are a vapor expansion predistillation unit or prerectification unit, a rectification column and also condensers and water separators. In the workup system 41, the vaporous middle distillate is separated by distillation into four groups, namely low boilers (hydrocarbon in the boiling range of kerosene and benzene), middle product (gas oil, namely hydrocarbon mixture in the boiling range of diesel), high boilers (process oil or carrier oil) and bottom product (distillation residues).

The reactor 11 is structurally equipped with a double cone shape in the bottom region. The reactor 11 has a top cylindrical wall section 43 having a bottom part 44, wherein the bottom part 44 has a conically tapering top wall section 45, a conically tapering bottom wall section 46 and a cylindrical central wall section 47. In the region of the bottom part 44, outlet ports 50, 51 are welded in, and also an outlet port 52 for filter bed material 42, which is a component of the bottom circuit.

A double shell in the region of the top cylindrical wall section 43 serves for additional heat transfer/cooling with a liquid heat carrier, namely thermal oil. The double shell is fabricated in such a manner that the thermal oil introduced via the top inlet port 48 flows around the reactor 11 via a guide appliance mounted spirally on the reactor outer wall and leaves the double shell at an outlet port 49. Furthermore, the reactor 11 has flow-deflecting internals in the region of the lid thereof.

The reactor 11 may be divided into four zones I-IV. The top zone I is a gas/vapor zone. Here a small amount of middle distillate vapor flows from the mixing zone II beneath into the degasser 37. In the top zone I, the internals for flow deflection are also arranged.

In the top section of the mixing zone II, in the region of an inlet port 53, the hydrocarbon-rich process oil mixture stream 26 is introduced tangentially into the mixing zone II and mixes with the process oil mixture 54 which is present there. In addition, in the mixing zone II mixing takes place with a process oil mixture stream 55 from the degasser 37, which process oil mixture stream 55 is relieved from vaporous middle distillate 2. On account of the tangential introduction procedure, the entire liquid rotates in the reactor 11. The rotary motion is additionally kept in motion via the deflected liquid medium from the degasser 37. The direction of motion of the rotating process oil mixture 54 and the relieved process oil mixture stream 55 correspond to one another.

A sedimentation zone III is a third section of the reactor 11 and is situated in the top cone segment. Here some of the process oil mixture 54 is transported using the pumps 57, 58, 59 as process oil mixture stream 56 which is to be heated through the ports 50 from the reactor 11 to the three mixing heat exchangers 38, 39, 40.

In a bottom zone IV of the reactor 11, i.e. in the bottom cone segment, the process oil mixture 54 is enriched with catalyst and additive in a high-boiling hydrocarbon matrix. The bottom zone IV is a second sedimentation zone. From the bottom zone IV, a process oil mixture stream 60 which is enriched with catalyst 1a and the additive 1b is mixed by means of the pumps 61, 62, 63 as needed with the process oil mixture stream 56 which is to be heated. A substream 56a of the process oil mixture stream 56 which is to be heated and a substream 60a of the enriched process oil mixture stream 60 form the process oil mixture stream 22 which is passed to the screw feed mixer 18 and in which the energy source 1 is dissolved before its entry into the reactor 11.

The mixing heat exchangers 38, 39, 40 each consist of two mixing heat exchanger units flanged together, wherein mixing heat exchanger units having the trade name “CSE-XR” from Fluitec are used. Between the tube bundles of the mixing heat exchanger units, mixing elements are welded on which lead to a turbulent mixing of the process oil mixture.

Shortly before the process oil mixture stream 56 and optionally the enriched process oil mixture stream 60 are transported into the three mixing heat exchangers 38, 39, 40, optionally catalyst 1a, and optionally additive 1b are added. In the mixing heat exchangers 38, 39, 40, the components are then turbulently mixed and heated to approximately 380° C. The heating proceeds via a liquid heat carrier, namely thermal oil, which is fed via inlet port 64 and removed via outlet port 65. Furthermore, the mixing heat exchangers 38, 39, 40 have inlet and outlet ports for a cleaning oil and also ports for introducing nitrogen.

The process oil mixture stream 56 and optionally the enriched process oil mixture stream 60 and also optionally the added catalyst 1a and optionally the added additive 1b arrive as heated process oil mixture stream 67 from the mixing heat exchangers 38, 39, 40 into the top region 66 of the degasser 37. In the top region 66, the degasser 37 has a dividing space having flow-guiding and surface-area-enlarging internals for dividing and surface area enlargement of the heated process oil mixture stream 67. The process oil mixture stream 67 is in part preferably applied centrally into the dividing space from the top onto the internals in the top region 66 of the degasser 37.

Furthermore, the degasser 37 has at least one inlet port for a substream 68 of the heated process oil mixture stream 67, wherein the substream 68 is transported tangentially into the degasser 37 in the top region 66 of the degasser below the internals and flows downwards rotating on the vessel inner wall of the degasser 37.

From the internals of the degasser 37, the process oil mixture 67 flows down as a trickling film, wherein owing to the fine division, a large surface area is created which facilitates the exit of cracked hydrocarbon chains from the process oil mixture 67. These convert into the vapor phase and flow as vaporous middle distillate 2 to the workup system 41. The thin streams flow off together with the substream 68 flowing downwards rotating on the vessel inner wall and pass into the four-phase reactor 11. Shortly after entry, they meet the internals in the gas-vapor zone I of the reactor 11, are deflected, and the circuit begins again from the start.

The process described with reference to FIGS. 1 and 2 for generating vaporous middle distillate 2 is distinguished by a statically forced absolutely turbulent mixing of the process oil mixture in the mixing heat exchangers 38, 39 and 40. This minimizes the heat transfer gradients and the system is fed in a self-cleaning manner with the process oil solids mixture (catalysts, mineral additives).

As additives 1b, lime hydrate, soda, clay flours and bentonites can be used. As catalyst 1a, preferably mineral zeolite solids are used. The preferably continuous solids addition of catalyst 1a and/or additive 1b is in the range from 0.5 to 20% by weight with respect to the process oil mixture 54 in the reactor 11. Catalysts 1a and additives 1b such as soda and lime hydrate are generally transported at a portion of 1 to 10% by weight, preferably 1 to 5% by weight, to the material feed of the energy source 1 into the reactor 1.

In the sedimentation zone III of the reactor 11, partially undissolved waste material, the catalyst 1a and additives 1b sediment. The catalyst mixed bed thus formed in the bottom zone IV is by means of at least one volumetrically operating pump 69 by transport back via the top part of the bottom zone IV to the mixed catalyst fluidized bed. Thereby, optionally the catalyst 1a and the additive 1b can be repeatedly utilized for the material reaction. The mixed fluidized bed is kept at a constant height by partial discharge of filter bed material 42 by means of the pump 69. A drain-off tank 70 is provided for running down the process.

1-33. (canceled)

34. A process for generating middle distillate from hydrocarbonaceous energy sources, which comprises the steps of:
feeding at least one hydrocarbonaceous energy source as an input material to a reactor containing a process oil mixture;
removing a process oil mixture stream from the reactor;
heating the process oil mixture stream to a process temperature between 150° C. and 400° C. resulting in a heated process oil mixture stream;
feeding the heated process oil mixture stream to a degasser;
separating, in the degasser, a vaporous middle distillate from the heated process oil mixture stream; and
recirculating the heated process oil mixture stream relieved of the vaporous middle distillate from the degasser to the process oil mixture present in the reactor.

35. The process according to claim 34, which further comprises applying the heated process oil mixture stream at least in part from a top into the degasser and is divided on internals of the degasser into a multiplicity of substreams, wherein the substreams flow off in a trickling film flow to the reactor.

36. The process according to claim 34, which further comprises introducing a substream of the heated process oil mixture stream tangentially into the degasser and flows off downward toward the reactor as a rotary flow on an inner vessel wall of the degasser.

37. The process according to claim 34, wherein a main energy input during the heating of the process oil mixture stream to the process temperature proceeds via an indirect heat transfer from a liquid heat source to the process oil mixture stream in at least one static mixer having an integrated heat transfer appliance.

38. The process as claimed in claim 37, wherein a turbulent flow of the process oil mixture stream forms in the static mixer.

39. The process according to claim 34, wherein an indirect heat transfer of the process oil mixture present in the reactor is provided, and a heat transfer proceeds from a heat source to the process oil mixture via an outer wall of the reactor.

40. The process according to claim 34, which further comprises deflecting the process oil mixture stream relieved of the vaporous middle distillate on entry into the reactor, and a tangential rotary flow is generated on a reactor wall.

41. The process according to claim 34, which further comprises passing a further process oil mixture stream from the reactor into a prereactor having a mixing appliance and the input material is fed to the prereactor and mixed with the further process oil mixture stream in the prereactor and in that a resultant hydrocarbon-rich process oil mixture stream is recirculated from the prereactor to the reactor.

42. The process according to claim 41, which further comprises mixing the hydrocarbon-rich process oil mixture stream recirculated from the prereactor with the process oil mixture present in the reactor and the process oil mixture stream from the degasser relieved from the vaporous middle distillate.

43. The process according to claim 41, which further comprises introducing, the hydrocarbon-rich process oil mixture stream recirculated from the prereactor, tangentially into a reactor mixing zone containing the process oil mixture, such that a rotary flow forms of all of the process oil mixture in the reactor.

44. The process according to claim 43, wherein a direction of rotation of the process oil mixture stream relieved of the vaporous middle distillate after entry into the reactor corresponds to a direction of rotation of the hydrocarbon-rich process oil mixture stream.

45. The process according to claim 41, which further comprises setting a volume ratio of the process oil mixture in the reactor and further process oil mixture in the prereactor to 1:5 to 1:8.

46. The process according to claim 34, which further comprises removing the process oil mixture stream which is to be heated from a top first sedimentation zone of the reactor and passed to a static mixer having an integrated heat transfer appliance.

47. The process according to claim 34, wherein from a bottom second sedimentation zone of the reactor, a further process oil mixture stream enriched with at least one catalyst is removed.

48. The process according to claim 41, wherein a substream of the process oil mixture stream which is to be heated and, a further substream of an enriched process oil mixture stream which is enriched with catalyst and a neutralizer form the further process oil mixture stream passed to the prereactor.

49. The process according to claim 48, wherein shortly before transport of the process oil mixture stream which is to be heated and of the enriched process oil mixture stream into a static mixer having an integrated heat transfer appliance, at least one catalyst and at least one additive is added.

50. The process according to claim 49, wherein at least one of the catalyst and the additive are emulsified in a carrier oil before the addition.

51. The process according to claim 34, which further comprises:
feeding at least one catalyst and at least one additive as additional input materials to a reactor along with the hydrocarbonaceous energy source;
heating the process oil mixture stream to a process temperature between 350° C. and 380° C.

52. The process according to claim 51, which further comprises mixing the hydrocarbonaceous energy source, the catalyst and the additive before being fed into the prereactor and are heated to a temperature of below 120° C.

53. The process according to claim 51, which further comprises continuously charging the reactor with the hydrocarbonaceous energy source, the catalyst and the additive.

54. The process according to claim 51, which further comprises mixing the hydrocarbonaceous energy source, the catalyst and the additive before being fed into the prereactor and are heated to a temperature of between 80 to 100° C.

55. The process according to claim 34, wherein from a bottom second sedimentation zone of the reactor, a process oil mixture stream enriched with at least one conically tapering catalyst and with at least one additive is removed and mixed with the process oil mixture stream which is to be heated.

56. A device for carrying out a process for generating middle distillate from hydrocarbonaceous energy sources, the device comprising:
at least one degasser having a top dividing space and a bottom degassing space, said degasser having flow-guiding and surface-area-increasing internals disposed in said top dividing space for dividing a process oil mixture stream and for increasing a surface area of the process oil mixture stream, the process oil mixture stream can be delivered centrally into said top dividing space from a top onto said internals;
a reactor disposed downstream of said degasser, a hydrocarbonaceous energy source being fed as an input material to said reactor containing a further process oil mixture, the further process oil mixture stream being removed from said reactor, the further process oil mixture stream being heated to a process temperature between 150° C. and 400° C. resulting in a heated process oil mixture stream, the heated process oil mixture stream being fed to said degasser;
said degasser separating the vaporous middle distillate from the heated process oil mixture stream and the heated process oil mixture stream relieved of the vaporous middle distillate is recirculated from said degasser to the further process oil mixture present in said reactor.

57. The device according to claim 56, wherein said bottom degassing space contains at least one inlet for a substream of the process oil mixture stream such that the substream can be introduced tangentially into said degasser and flows off downward toward said reactor as a rotary flow in an inner vessel wall of said bottom degassing space.

58. The device according to claim 56, further comprising at least one static mixer having an integrated heat transfer appliance, said static mixer is constructed as a mixing heat exchanger having a multiplicity of tube bundles for a heat carrier and mixing elements between said tube bundles for turbulent mixing of the process oil mixture stream.

59. The device according to claim 58, wherein said reactor containing the further process oil mixture has a top cylindrical wall section.

60. The device according to claim 59, wherein said reactor has a reactor wall, a top entry region into said reactor, and internals for deflecting a flow of the further process oil mixture disposed in said top entry region, said internals are constructed for generating a tangential wall flow along said reactor wall.

61. The device according to claim 59, wherein said reactor has a bottom part having a conically tapering top wall section, a conically tapering bottom wall section, and a cylindrical wall section, said conically tapering top wall section and said conically tapering bottom wall sections are connected to one another by said cylindrical wall section.

62. The device according to claim 59, wherein said reactor has a conically tapering top wall section, and said conically tapering top wall section has a top region with at least one outlet formed therein.

63. The device according to claim 59, wherein said reactor has a conically tapering bottom wall section, and said conically tapering bottom wall section has a top region with at least one further outlet formed therein.

64. The device according to claim 59, further comprising one of an open-loop control appliance and a closed-loop control appliance for one of open-loop control and closed-loop control of a volumetric flow ratio of at least two process oil mixture streams.

65. The device according to claim 56, further comprising:
at least one prereactor having at least one feed screw as a feed unit, for the energy source, a catalyst and an additive; and
a mixing vessel connected to said feed screw, said feed screw engages as far as to a bottom region of said mixing vessel and contains mixing flights at a bottom end.

66. The device according to claim 65, wherein said feed screw is at least one of heatable and coolable.

67. The device according to claim 65, wherein said mixing vessel contains at least one bottom inlet and at least one top outlet for a process oil mixture stream.

68. The device according to claim 67, wherein at least one of said bottom inlet and said top inlet is constructed for tangential feed of the process oil mixture stream into said mixing vessel.

69. The device according to claim 65, wherein a carrier oil can be fed into said reactor via said mixing vessel.

70. The device according to claim 59, wherein:
said top wall section is constructed as a double-shell cylinder having a reactor inner wall and a reactor outer wall; and
said reactor having a reactor wall and a guide appliance which is spirally mounted on said reactor wall and provided for a heat carrier, said guide appliance disposed in said double-shell cylinder.

71. The device according to claim 65, wherein said at least one feed screw is a double screw.
